(19) United States
(12) Patent Application Publication
(10) Pub. No.: US 2016/0149238 A1
(43) Pub. Date: May 26, 2016

(54) APPARATUS AND METHOD FOR CONTROLLING COOLING PUMP OF FUEL CELL SYSTEM

(71) Applicant: Hyundai Motor Company, Seoul (KR)

(72) Inventors: Hyun Jae Lee, Seoul (KR); Deuk Kuen Ahn, Anyang (KR)

(21) Appl. No.: 14/690,392

(22) Filed: Apr. 18, 2015

(30) Foreign Application Priority Data
Nov. 26, 2014 (KR) 10-2014-0166512

(51) Int. Cl. H01M 8/0432; H01M 8/04992; H01M 8/04701; H01M 8/04029; H01M 8/04007

(52) U.S. Cl. CPC H01M 8/04358; H01M 8/04029; H01M 8/04067; H01M 8/04723; H01M 8/04992

(57) ABSTRACT

A method and apparatus for controlling a cooling pump of a fuel cell system are provided that improve efficiency of the fuel cell system by variably adjusting idle RPM of a pump that cools down stacks within the fuel cell system, based on temperature and flowrate of coolant The apparatus includes a storage that is configured to store a table in which revolutions per minute (RPM) of the cooling pump corresponding to temperature are recorded and a temperature measurer that is configured to measure temperature of a coolant of fuel cell stacks. In addition, a controller operates a pump driver based on the stored table to adjust the RPM of the cooling pump to correspond to the measured temperature of the coolant

### CROSS-REFERENCE TO RELATED APPLICATION

This application is based on and claims the benefit of priority to Korean Patent Application No. 10-2014-0166512, filed on Nov. 26, 2014 in the Korean Intellectual Property Office, the disclosure of which is incorporated herein in its entirety by reference.

### TECHNICAL FIELD

The present disclosure relates to an apparatus and method for controlling a cooling pump of a fuel cell system, and more particularly, to a technology for variably adjusting idle revolutions per minute (RPM) of a pump to cool down stacks within a fuel cell system, based on temperature and flowrate of coolant.

### BACKGROUND

Generally, a fuel cell is a type of power generator that converts chemical energy of the fuel into electric energy by an electrochemical reaction within stacks, rather than converting the energy into heat by combustion. The fuel cell is adaptable to supply electric power for industrial and home use and for driving vehicles, and also supply electric power to small-sized electric/electronic products, or more specifically, to a portable device. For a source of electric power to drive vehicles, the polymer electrolyte membrane fuel cell/proton exchange membrane fuel cell (PEMFC) form having the highest power density among fuel cells is currently being researched, and such a cell has fast starting time and fast power conversion response time due to low operating temperature.

This PEMFC includes a membrane electrode assembly (MEA) that has a catalytic electrode layer for electrochemical reaction which is attached on both sides of a membrane with reference to a solid polymer electrolyte membrane where hydrogen ion moves, a gas diffusion layer (GDL) that evenly distribute reactive gases and deliver generated electric energy, a gasket and a fastener to maintain airtightness of reactive gases and coolant and also to maintain sufficient clamping pressure, and a bipolar plate to move the reactive gases and the coolant

When fuel cell stacks are assembled using these unit cells, a combination of the main components (i.e., combination of MEA and GDL) is positioned at an innermost location of the cell, in which the MEA has a catalytic electrode layer with catalyst coated on both surfaces of the polymer electrolyte membrane (i.e., anode and cathode) to allow reaction to occur between hydrogen and oxygen, and the GDL, gasket and others are stacked on the outer portions of the anode and the cathode.

The bipolar plate is positioned on the outer side of the GDL, and has a flow field to supply reactive gas (i.e., hydrogen as fuel, and oxygen or air as oxidizer), and permits coolant to pass therethrough. The resultant structure is used as a unit cell to stack a plurality of unit cells after which the current collector and insulator, and end plates to support the stacked cells are coupled onto the outermost sides. In other words, the fuel cell stacks are constructed by repeatedly stacking and coupling the unit cells between the end plates.

Meanwhile, it is necessary to maintain particular temperature for efficient fuel cell reaction of the fuel cell stacks, thus the fuel cell system includes a cooling pump configured to cool down the stack by circulating coolant. The conventional apparatus for operating cooling pump adjusts the increase and decrease RPM of the pump according to temperature changes of the temperature sensor formed on a front end, or a rear end or both ends of the fuel cell stack, by decreasing RPM of the pump to perform power save cooling of the coolant when the temperature decreases, while increasing RPM of the pump to perform rapid cooling of the coolant when the temperature rises.

As explained above, conventional technologies overlook the fact that the cooling effect obtained by increasing the RPM of the pump is insignificant, once the temperature of the coolant rises above a preset value, thus having a problem of disadvantageously decreasing efficiency of the fuel cell system due to unnecessary consumption of the power.

### SUMMARY

The present disclosure provides an apparatus and method for controlling a cooling pump of a fuel cell system which is capable of enhancing efficiency of the fuel cell system by variably adjusting idle RPM of a pump that cools down stacks within the fuel cell system, based on temperature and flowrate of coolant.

Another aspect of the present disclosure provides an apparatus and method for controlling a cooling pump of a fuel cell system which is capable of enhancing fuel efficiency of a fuel cell vehicle, by variably adjusting idle RPM of a pump that cools down stacks within a fuel cell system, based on temperature and flowrate of coolant.

The aspects of the present disclosure are not limited to those mentioned above, and other aspects and advantages of the present disclosure that are not specified herein are understandable by the following description and will be more apparent based on the exemplary embodiments of the present disclosure. Further, those skilled in the art will be easily able to know that the aspects and advantages of the present disclosure can be achieved by the means indicated in the claims and a combination thereof.

According to an exemplary embodiment of the present disclosure, an apparatus for controlling a cooling pump of a fuel cell system may include a storage (e.g., a memory) configured to store a table in which revolutions per minute (RPM) of the cooling pump corresponding to temperature are recorded, a temperature measurer (e.g., sensor) configured to measure temperature of a coolant of fuel cell stacks, a controller configured to operate a pump driver based on the stored table to adjust the RPM of the cooling pump to correspond to the temperature of the coolant as measured by the temperature measurer, and the pump driver configured to drive the cooling pump under control of the controller.

According to another exemplary embodiment of the present disclosure, an apparatus for controlling a cooling pump of a fuel cell system may include a storage configured to store a reference temperature range (α˜β), a minimum flowrate (γ) and a maximum flowrate (δ) in the reference temperature range, and an initial RPM (Z₁), a temperature measurer configured to measure a temperature (T) of a coolant of fuel cell stacks, a flowrate calculator configured to calculate a flowrate (L) of the coolant based on the reference temperature range and the minimum flowrate and the maximum flowrate in the reference temperature range, as the temperature measured by the temperature measurer is included in the reference temperature range, a controller configured to calculate the RPM of the cooling pump using the flowrate calculated by the flowrate calculator and the minimum flowrate in the reference temperature range and the initial RPM (Z₁), and operate a pump driver to adjust the RPM of cooling pump to the calculated RPM, and the pump driver configured to drive the cooling pump.

According to exemplary embodiment of the present disclosure, a method for controlling a cooling pump of a fuel cell system may include storing, by a storage, a table in which revolutions per minute (RPM) of the cooling pump corresponding to temperature are recorded, measuring, by a temperature measurer, temperature of a coolant of fuel cell stacks, operating, by a controller, a pump driver based on the stored table stored at the storage to adjust the RPM of the cooling pump to correspond to the temperature of the coolant as measured by the temperature measurer, and driving, by the pump driver, the cooling pump under control of the controller.

According to another exemplary embodiment of the present disclosure, a method for controlling a cooling pump of a fuel cell system may include storing, by a storage, a reference temperature range (α˜β), a minimum flowrate (γ) and a maximum flowrate (δ) in the reference temperature range, and an initial RPM (Z₁), measuring, by a temperature measurer, a temperature (T) of a coolant of fuel cell stacks, calculating, by a flowrate calculator, a flowrate (L) of the coolant based on the reference temperature range and the minimum flowrate and the maximum flowrate in the reference temperature range, as the temperature measured by the temperature measurer is included in the reference temperature range, calculating, by a controller, the RPM of the cooling pump using the flowrate calculated by the flowrate calculator and the minimum flowrate in the reference temperature range and the initial RPM (Z₁), and operating, by the controller, a pump driver to adjust the RPM of the cooling pump to the calculated RPM, and driving, by the pump driver, the cooling pump.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary block diagram of an apparatus for controlling a cooling pump of a fuel cell system according to an exemplary embodiment of the present disclosure;

FIG. 2 is an exemplary block diagram of an apparatus for controlling a cooling pump of a fuel cell system according to another exemplary embodiment of the present disclosure;

FIG. 3 is an exemplary view showing flowrate changing in accordance with the temperature of coolant, according to an exemplary embodiment of the present disclosure;

FIG. 4 is an exemplary flowchart illustrating a method for controlling a cooling pump of a fuel cell system according to an exemplary embodiment of the present disclosure; and

FIG. 5 is an exemplary flowchart illustrating a method for controlling a cooling pump of a fuel cell system according to another exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

An exemplary embodiment of the present disclosure will be described in detail with reference to the accompanying drawings.

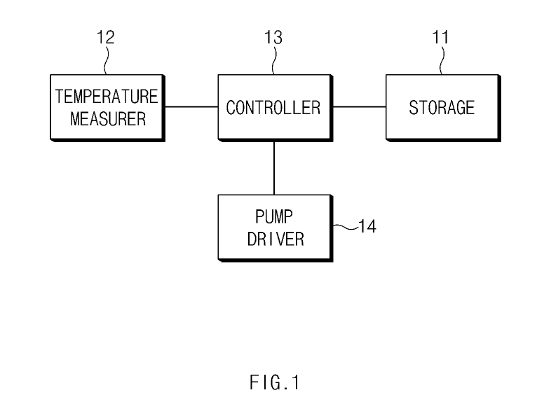

FIG. 1 is an exemplary block diagram of an apparatus for controlling a cooling pump of a fuel cell system according to an exemplary embodiment of the present disclosure. Referring to FIG. 1, an apparatus for controlling a cooling pump of a fuel cell system according to an exemplary embodiment may include a storage 11, a temperature measurer 12, a controller 13 and a pump driver 14. The controller 13 may be configured to operate the storage (e.g., memory) 11, the temperature measurer (e.g., sensor) 12, and the pump driver 14.

In particular, the storage 11 may be configured to store a table of revolutions per minute (RPM) of a cooling pump that correspond to the temperature of the coolant to cool down fuel cell stacks. For example, the table may be in the following form.

TABLE 1

| | Temperature range | | |
|---|---|---|---|
| | X ≦ Y1 | Y1 < X ≦ Y2 | X > Y2 |
| RPM | 2,500 | 2,200 | 2,000 |

wherein, X denotes current coolant temperature, and Y1 and Y2 denote threshold temperatures. In other words, when the current temperature of the coolant is equal to or less than Y1 (i.e., in the first temperature range), the RPM of the cooling pump may be adjusted to be about 2,500, when the current coolant temperature exceeds Y1 and equal to or less than Y2 (i.e., in the second temperature range), the RPM of the cooling pump may be adjusted to be about 2,200, and when the current coolant temperature exceeds Y2 (i.e., in the third temperature range), the RPM of the cooling pump may be adjusted to be about 2,000.

The RPMs in the respective temperature ranges are provided only for exemplary purpose, and accordingly, are modifiable depending on intention of a designer, provided that the RPM of the cooling pump is higher in the order of ‘first temperature range>second temperature range>third temperature range.’

As noted above, instead of following a routine of increasing the RPM of the cooling pump when the temperature is greater than a predetermined temperature threshold and decreasing the RPM of the cooling pump when the temperature is below a predetermined temperature threshold, the RPM of the cooling pump may be decreased with respect to an initial value until the coolant temperature exceeds Y2, and the RPM of the cooling pump may be maintained at a substantially constant level once the Y2 is exceeded, based on consideration of the technical concept that the cooling effect obtained by increasing the RPM of the cooling pump is insufficient once the coolant temperature increases above a preset value.

Further, the temperature measurer 12, which may be implemented as a temperature sensor, may be configured to measure the temperature of the coolant of the fuel cell stacks. The controller 13 may be configured to execute overall control so that the respective components normally perform intended functions. In particular, the controller 13 may be configured to operate the pump driver 14 based on the stored table in the storage 11 to adjust the RPM of the cooling pump to correspond to the temperature of the coolant as measured by the temperature measurer 12. The pump driver 14 may be configured to drive the cooling pump under control of the controller 13. In other words, the pump driver 14 may be configured to drive the cooling pump to operate at a RPM that corresponds to the coolant temperature.

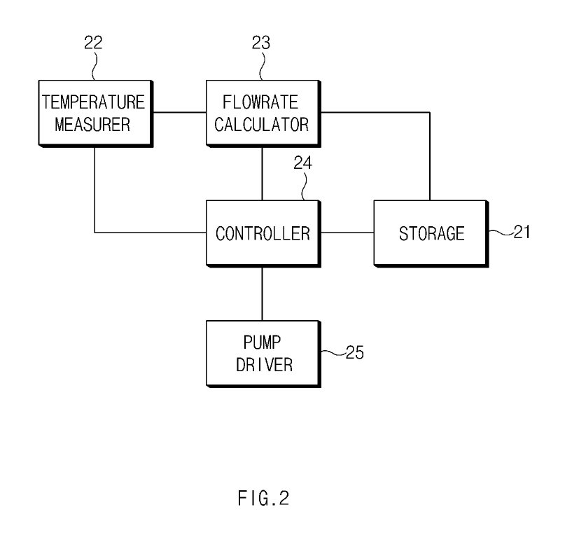

FIG. 2 is an exemplary block diagram of an apparatus for controlling a cooling pump of a fuel cell system according to another exemplary embodiment of the present disclosure. Referring to FIG. 2, the apparatus for controlling the cooling pump of a fuel cell system according to another exemplary embodiment of the present disclosure may include a storage 21, a temperature measurer 22, a flowrate calculator 23, a controller 24 and a pump driver 25. In particular, the storage 21 may be configured to store a reference temperature range of coolant to cool down fuel cell stacks, minimum and maximum flowrates within the reference temperature range, and initial RPM.

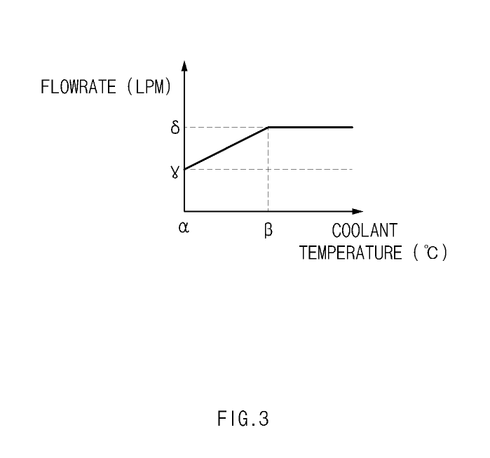

The reference temperature range of the coolant, the minimum and maximum flowrates in the reference temperature range will be explained in detail below with reference to FIG. 3. FIG. 3 illustrates flowrate changes in accordance with the coolant temperature, according to an exemplary embodiment of the present disclosure. Referring to FIG. 3, a denotes starting point of the reference temperature range, β is an ending point of the reference temperature range, γ is a flowrate at the starting point of the reference temperature range, and δ is a flowrate at the ending point of the reference temperature range. All of α,β,γ,δ are constants.

Furthermore, the temperature measurer 22, which may be implemented as a temperature sensor, for example, may be configured to measure the temperature of the coolant of the fuel cell stacks. The flowrate calculator 23 may be executed by the controller to calculate liter per minute (LPM) of the coolant to circulate to thus cool down the fuel cell stacks. In other words, when the temperature (T) measured by the temperature measurer 22 is included in the reference temperature range, the flowrate calculator 23 may be configured to calculate the flowrate of the coolant based on the reference temperature range (α˜β), and minimum flowrate (γ) and maximum flowrate (δ) in the reference temperature range stored at the storage 21. For example, the flowrate (L) of the coolant may be calculated using Mathematical expression 1 as below.

L=(δ−γ)÷(β−α)×(T−α)+γ Mathematical expression 1

Furthermore, the controller 24 may be configured to execute overall control so that the respective components perform given functions normally In particular, the controller 24 may be configured to calculate the RPM of the cooling pump, using the flowrate calculated by the flowrate calculator 23, and the minimum flowrate (γ) in the reference temperature range and initial RPM (Z₁) as stored in the storage 21. For example, the RPM (Z) of the cooling pump may be calculated using Mathematical expression 2 as below.

Z=(γ÷L)×Z₁ Mathematical expression 2

Then, the controller 24 may be configured to operate the pump driver 25 to adjust the RPM of the cooling pump to be the RPM as calculated above. Meanwhile, when the temperature measured by the temperature measurer 22 exceeds the maximum value in the reference temperature range, the controller 24 may be configured to calculate the RPM of the cooling pump based on the flowrate at the maximum value, and then may be configured to operate the pump driver 25 to adjust the RPM of the cooling pump to the calculated RPM.

The pump driver 25 may then be configured to drive the cooling pump under control of the controller 24. In other words, the pump driver 25 may be configured to drive to operate with the RPM corresponding to the temperature of the coolant Although the flowrate calculator 23 and the controller 24 are described herein as the separate components from each other, the controller 24 may be implemented to perform the function of the flowrate calculator 23.

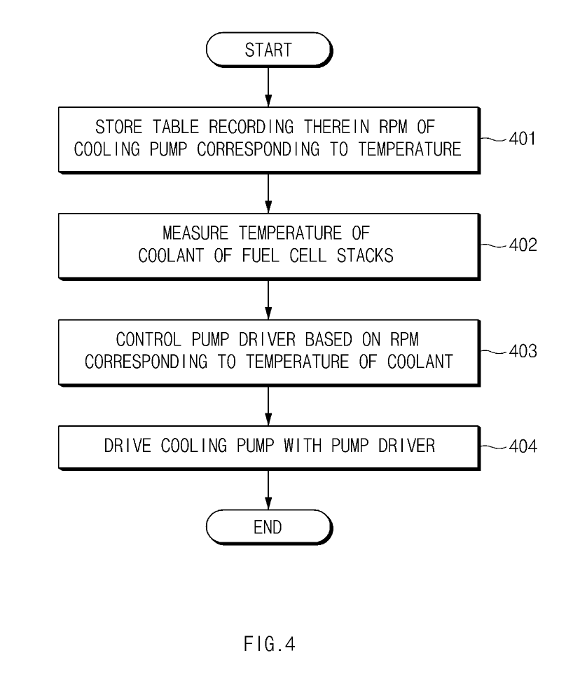

FIG. 4 is an exemplary flowchart illustrating a method for controlling a cooling pump of a fuel cell system according to an exemplary embodiment of the present disclosure. First, at step 401, the storage 11 may be configured to store a table in which RPM of the cooling pump corresponding to temperature is recorded. Next, at step 402, the temperature measurer 12 may be configured to measure the temperature of the coolant of the fuel cell stacks.

As step 403, based on the table stored in the storage 11, the controller 13 may be configured to operate the pump driver 14 to adjust the RPM of the cooling pump to correspond to the temperature of the coolant measured by the temperature measurer 12. Further, at step 404, the pump driver 14 may be configured to drive the cooling pump under control of the controller 13.

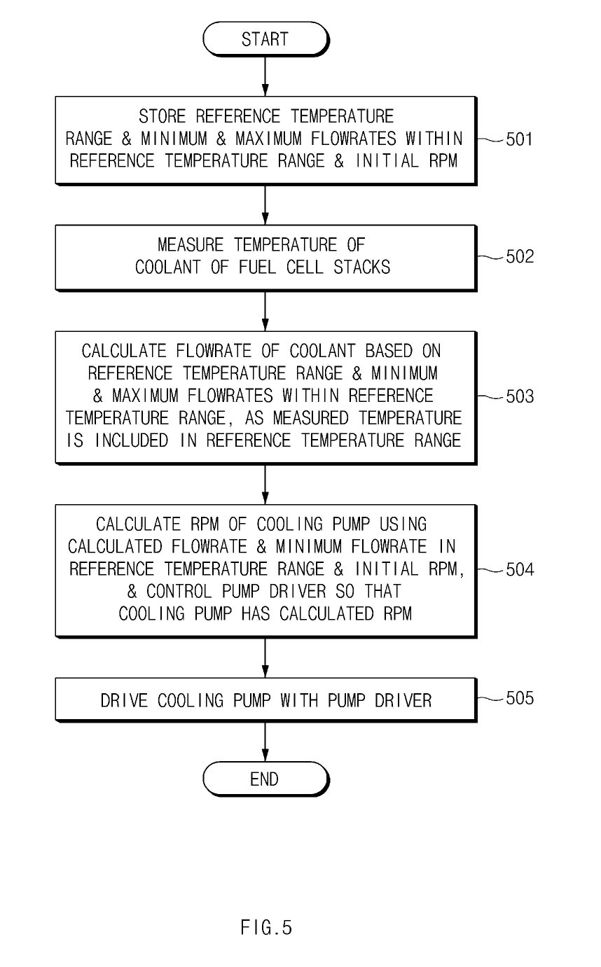

FIG. 5 is an exemplary flowchart illustrating a method for controlling a cooling pump of a fuel cell system according to another exemplary embodiment of the present disclosure. First, at step 501, the storage 21 may be configured to store the reference temperature range (α˜β), minimum flowrate (γ) and maximum flowrate (δ) in the reference temperature range (α-β), and initial RPM (Z₁).

Additionally, at step 502, the temperature measurer 22 may be configured to measure the temperature (T) of the coolant of the fuel cell stacks. At step 503, as the temperature measured by the temperature measurer 22 is included in the reference temperature range, the flowrate calculator 23 may be configured to calculate the flowrate (L) of the coolant based on the reference temperature range, and the minimum flowrate and the maximum flowrate in the reference temperature range. Then, at step 504, the controller 24 may be configured to calculate the RPM of the cooling pump using the flowrate calculated by the flowrate calculator 23 and the minimum flowrate in the reference temperature range and the initial RPM (Z₁), and operate the pump driver 25 so that the cooling pump operates at the calculated RPM. At step 505, the pump driver 25 may be configured to drive the cooling pump under control of the controller 24.

As described above, according to the exemplary embodiments of the present disclosure, efficiency of a fuel cell system may be enhanced by variably adjusting the idle RPM of a pump to cool down a stack within a fuel cell system, based on temperature and flowrate of coolant. Further, when adopted in a fuel cell vehicle, fuel efficiency of the fuel cell vehicle may be enhanced.

Meanwhile, methods according to the exemplary embodiments described above are writable as computer program. Codes and code segments for constituting the program can be easily envisioned by a computer programmer in the art. The written program is stored at a computer-readable recording medium (i.e., information storage medium) so that the methods of the present disclosure are implemented by being read and executed by a computer. The recording medium encompasses all forms of recording medium that are readable by a computer.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a cooling pump of a fuel cell system, comprising:
a storage configured to store a table in which revolutions per minute (RPM) of the cooling pump corresponding to temperature are recorded;
a temperature measurer configured to measure temperature of a coolant of fuel cell stacks; and
a controller configured to operate a pump driver based on the stored table to adjust the RPM of the cooling pump to correspond to the temperature of the coolant as measured by the temperature measurer.

2. The apparatus according to claim 1, wherein the table includes three temperature ranges of a first temperature range, a second temperature range and a third temperature range, in which the temperature is higher in the order of the third temperature range, the second temperature range and the first temperature range, while the RPM is lower in the order of the third temperature range, the second temperature range and the first temperature range.

3. The apparatus according to claim 1, wherein, when the temperature measured by the temperature measurer exceeds a threshold value, the controller is configured to maintain the RPM of the cooling pump at a substantially constant level.

4. An apparatus for controlling a cooling pump of a fuel cell system, comprising:
a storage configured to store a reference temperature range (α˜β), a minimum flowrate (γ) and a maximum flowrate (γ) in the reference temperature range, and an initial revolutions per minute (RPM) (Z₁);
a temperature measurer configured to measure a temperature (T) of a coolant of fuel cell stacks;
a flowrate calculator configured to calculate a flowrate (L) of the coolant based on the reference temperature range and the minimum flowrate and the maximum flowrate in the reference temperature range, as the temperature measured by the temperature measurer is included in the reference temperature range; and
a controller configured to calculate RPM of the cooling pump using the flowrate calculated by the flowrate calculator and the minimum flowrate in the reference temperature range and the initial RPM (Z₁), and operate a pump driver to adjust the RPM of the cooling pump to the calculated RPM.

5. The apparatus according to claim 4, wherein the flowrate calculator is configured to calculate the flowrate (L) based on following mathematical expression A:
L=(δ−γ)÷(β−α)×(T−α)+γ, Mathematical expression A
wherein L is the flowrate, γ is a minimum flowrate, δ is a maximum flow rate, T is a temperature, α denotes starting point of the reference temperature range, and β is an ending point of the reference temperature range.

6. The apparatus according to claim 5, wherein the controller is configured to calculate the RPM (Z) of the cooling pump using following mathematical expression B:
Z=(γ÷L)×Z₁, Mathematical expression B
wherein Z is the RPM, γ is a minimum flowrate, L is the flowrate, and Z₁ is the initial RPM.

7. The apparatus according to claim 4, wherein, when the temperature measured by the temperature measurer exceeds a maximum value in the reference temperature range, the controller is configured to calculate the RPM of the cooling pump based on a flowrate at the maximum value, and is configured to operate the pump driver to adjust the RPM of the cooling pump to the calculated RPM.

8. A method for controlling a cooling pump of a fuel cell system, the method comprising:
storing, by a controller, a table in which revolutions per minute (RPM) of the cooling pump corresponding to temperature are recorded;
measuring, by the controller, a temperature of a coolant of fuel cell stacks using a temperature sensor; and
operating, by the controller, a pump driver based on the stored table to adjust the RPM of the cooling pump to correspond to the measured temperature of the coolant.

9. The method according to claim 8, wherein the table includes three temperature ranges of a first temperature range, a second temperature range and a third temperature range, in which the temperature is higher in the order of the third temperature range, the second temperature range and the first temperature range, while the RPM is lower in the order of the third temperature range, the second temperature range and the first temperature range.

10. The method according to claim 8, wherein, when the measured temperature exceeds a threshold value, the RPM of the cooling pump is maintained at a substantially constant level.

11. A method for controlling a cooling pump of a fuel cell system, the method comprising:
storing, by a controller, a reference temperature range (α˜β), a minimum flowrate (γ) and a maximum flowrate (δ) in the reference temperature range, and an initial RPM (Z₁);
measuring, by the controller, a temperature (T) of a coolant of fuel cell stacks using a temperature sensor;
calculating, by the controller, a flowrate (L) of the coolant based on the reference temperature range and the minimum flowrate and the maximum flowrate in the reference temperature range, as the measured temperature is included in the reference temperature range;
calculating, by the controller, a revolutions per minute (RPM) of the cooling pump using the calculated flowrate and the minimum flowrate in the reference temperature range and the initial RPM (Z₁); and
operating, by the controller, a pump driver to adjust the RPM of the cooling pump to the calculated RPM.

12. The method according to claim 11, wherein the calculating of the flowrate includes calculating the flowrate (L) based on following mathematical expression A:
L=(δ−γ)÷(β−α)×(T−α)+γ, Mathematical expression A
wherein L is the flowrate, γ is a minimum flowrate, δ is a maximum flow rate, T is a temperature, a denotes starting point of the reference temperature range, and β is an ending point of the reference temperature range.

13. The method according to claim 12, wherein the controlling calculates the RPM (Z) of the cooling pump using following mathematical expression B:
Z=(γ÷L)×Z₁, Mathematical expression B
wherein Z is the RPM, γ is a minimum flowrate, L is the flowrate, and Z₁ is the initial RPM.

14. The method according to claim 11, further comprising:
calculating, by the controller, the RPM of the cooling pump based on a flowrate at the maximum value when the temperature measured by the temperature measurer exceeds a maximum value in the reference temperature range; and
operating the pump driver to adjust the RPM of the cooling pump to the calculated RPM.
